(19) United States
(12) Patent Application Publication
(10) Pub. No.: US 2018/0054261 A1
(43) Pub. Date: Feb. 22, 2018

(54) METHOD AND APPARATUS FOR DATA TRANSMISSION

(71) Applicant: ORA INC., Beijing (CN)

(72) Inventors: LEI DING, Beijing (CN); Jia Jia Han, Beijing (CN); Huan Liu, Beijing (CN); Jian Guo Wu, Beijing (CN); Ye Zhao, Beijing (CN)

(21) Appl. No.: 15/719,471

(22) Filed: Sep. 28, 2017

Related U.S. Application Data
(63) Continuation of application No. PCT/CN2015/088411, filed on Aug. 28, 2015.

(30) Foreign Application Priority Data
Apr. 9, 2015 (CN) 201510164793.5

(51) Int. Cl. H04B 11/00; H04L 29/06

(52) U.S. Cl. CPC H04B 11/00; H04B 17/318; H04B 17/27; H04L 63/08

(57) ABSTRACT

The disclosure relates to a method and an apparatus for data transmission, where the method includes: a first mobile device transmits authentication data to a second mobile device via a sound wave, and transmits data to the second mobile device via a sound wave after the second mobile device has been successfully authenticated, thereby achieving data transmission between the first mobile device and the second mobile device via a sound generating apparatus, such as a microphone and a loudspeaker, in the first mobile device and the second mobile device, with small power consumption and no interference to the antenna related to the voice call of the mobile device.

### CROSS-REFERENCE TO RELATED APPLICATIONS

This application is a continuation of International Application No. PCT/CN2016/088411, filed on Aug. 28, 2015, which claims priority to Chinese Patent Application No. 201510164793.5, filed on Apr. 9, 2015. The disclosures of the aforementioned applications are hereby incorporated by reference in their entireties.

### TECHNICAL FIELD

The present disclosure relates to the field of communication technology and, in particular, to a method and an apparatus for data transmission.

### BACKGROUND

At present, when data is to be transmitted between mobile devices, the mobile devices need to have a Bluetooth, an NFC, a WIFI or the like turned on first in order to enable the mobile devices to search, discover and pair with each other, and the data transmission cannot happen between the mobile devices until successful pairing.

In the prior art, however, a mobile device needs to be provided with a special antenna to implement the functions of the Bluetooth, NFC, WIFI, etc., and the searching, discovery and pairing of mobile devices through a wireless signal transmitted via the antenna.

### SUMMARY

The present disclosure provides a method and an apparatus for data transmission to address the problem in the prior art that the power consumption is high and the antenna related to voice call of the mobile devices is potentially interfered when transmitting data between mobile devices via the special antenna.

A first aspect of the present disclosure provides a method for data transmission, the method includes:
obtaining, by a first mobile device, authentication data to be transmitted;
performing, by the first mobile device, protocol encapsulation, encoding and modulation on the authentication data to obtain modulated authentication data;
by the first mobile device, loading the modulated authentication data onto a sound wave and transmitting the sound wave to a second mobile device within a predefined range, so that the second mobile device returns an authentication success message to the first mobile device after the second mobile device has successfully performed demodulation, decoding and protocol handling on the modulated authentication data;
receiving, by the first mobile device, the authentication success message returned from the second mobile device; and
by the first mobile device, obtaining data to be transmitted, performing protocol encapsulation, encoding and modulation on the data to be transmitted to obtain modulated data to be transmitted, loading the modulated data to be transmitted onto a sound wave, and transmitting the sound wave to the second mobile device that has succeeded in the authentication.

Further, the authentication success message carries: a received power of the sound wave.

And before the first mobile device obtains data to be transmitted, performs protocol encapsulation, encoding and modulation on the data to be transmitted to obtain modulated data to be transmitted, loads the modulated data to be transmitted onto the sound wave, and transmits the sound wave to the second mobile device that has succeeded in the authentication, the method further includes:
obtaining, by the first mobile device, a transmitted power of the sound wave;
determining, by the first mobile device, a distance between the first mobile device and the second mobile device according to the received power and the transmitted power of the sound wave; and
adjusting, by the first mobile device, the transmitted power of the sound wave according to the distance.

Further, the authentication success message carries:
location information of the second mobile device.

And before the first mobile device obtains data to be transmitted, performs protocol encapsulation, encoding and modulation on the data to be transmitted to obtain modulated data to be transmitted, loads the modulated data to be transmitted onto the sound wave, and transmits the sound wave to the second mobile device that has been successfully authenticated, the method further includes:
obtaining, by the first mobile device, location information of itself;
determining, by the first mobile device and according to the location information of the first mobile device and the location information of the second mobile device, a distance between the first mobile device and the second mobile device, and a direction of the second mobile device relative to the first mobile device; and
adjusting, by the first mobile device, the transmitted power and a transmission direction of the sound wave according to the distance and the direction.

Further, before the first mobile device loads the modulated authentication data onto the sound wave and transmits the sound wave to the second mobile device within the predefined range, the method further includes:
encrypting, by the first mobile device, the modulated authentication data according to a predefined password.

Further, the sound wave is an ultrasonic wave with a frequency greater than or equal to 25 kHz.

Another aspect of the present disclosure provides an apparatus for data transmission, the apparatus includes:
an obtaining module, configured to obtain authentication data to be transmitted;
a modulating module, configured to perform protocol encapsulation, encoding and modulation on the authentication data to obtain modulated authentication data;
a transmitting module, configured to load the modulated authentication data onto a sound wave and transmit the sound wave to a second mobile device within a predefined range, so that the second mobile device returns an authentication success message to a first mobile device after the second mobile device has successfully performed demodulation, decoding and protocol handling on the modulated authentication data;
a receiving module, configured to receive the authentication success message returned from the second mobile device;
the obtaining module being further configured to obtain data to be transmitted;
the modulating module being further configured to perform protocol encapsulation, encoding and modulation on the data to be transmitted to obtain modulated data to be transmitted; and
the transmitting module being further configured to load the modulated data to be transmitted onto a sound wave and transmit the sound wave to the second mobile device that has succeeded in the authentication.

Further, the authentication success message carries: a received power of the sound wave;
and the apparatus further includes: a first determining module and a first adjusting module; the obtaining module being further configured to obtain a transmitted power of the sound wave before the transmitting module loads the modulated data to be transmitted onto the sound wave and transmits the sound wave to the second mobile device that has succeeded in the authentication;
the first determining module being configured to determine a distance between the first mobile device and the second mobile device according to the received power and the transmitted power of the sound wave; and
the first adjusting module being configured to adjust the transmitted power of the sound wave according to the distance.

Further, the authentication success message carries: location information of the second mobile device;
and the apparatus further includes: a second determining module and a second adjusting module;
the obtaining module being further configured to obtain location information of the first mobile device before the transmitting module loads the modulated data to be transmitted onto the sound wave and transmits the sound wave to the second mobile device that has succeeded in the authentication;
the second determining module being configured to determine, according to the location information of the first mobile device and the location information of the second mobile device, a distance between the first mobile device and the second mobile device, and a direction of the second mobile device relative to the first mobile device; and
the second adjusting module being configured to adjust the transmitted power and a transmission direction of the sound wave according to the distance and the direction.

Further, the apparatus further includes: an encrypting module;
the encrypting module being configured to encrypt the modulated authentication data according to a predefined password before the transmitting module loads the modulated authentication data onto the sound wave and transmits the sound wave to the second mobile device within a predefined range.

Further, the sound wave is an ultrasonic wave with a frequency greater than or equal to 25 kHz.

In this disclosure, a first mobile device transmits authentication data to a second mobile device via a sound wave, and transmits data to the second mobile device via a sound wave after the second mobile device has been successfully authenticated, thereby achieving data transmission between the first mobile device and the second mobile device via a sound generating apparatus, such as a microphone and a loudspeaker, in the first mobile device and the second mobile device, with small power consumption and no interference to the antenna related to the voice call of the mobile device.

### BRIEF DESCRIPTION OF DRAWINGS

FIG. 1 is a flowchart of an embodiment of a method for data transmission provided in the present disclosure;

FIG. 2 is a structural schematic diagram of an embodiment of an apparatus for data transmission provided in the present disclosure;

FIG. 3 is a structural schematic diagram of a further embodiment of an apparatus for data transmission provided in the present disclosure;

FIG. 4 is a structural schematic diagram of another embodiment of an apparatus for data transmission provided in the present disclosure.

### DESCRIPTION OF EMBODIMENTS

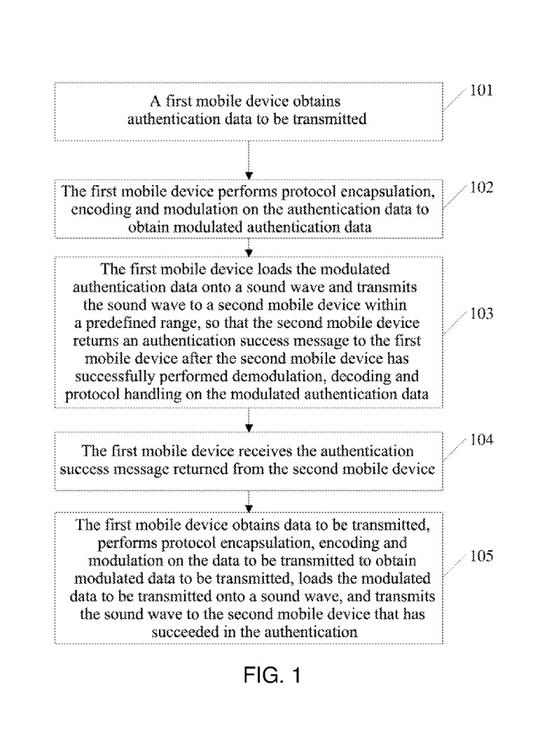

In order to make the purpose, technical solutions and advantages of the embodiments of the present disclosure clearer, the technical solutions of the embodiments of the present disclosure will be clearly and completely described below with reference to the accompanying drawings in the embodiments of the present disclosure. Apparently, the described embodiments are part of the embodiments of the present disclosure, rather than all of the embodiments. Based on the embodiments of the present disclosure, all other embodiments obtained by those skilled in the art without inventive labor are within the protection scope of the present disclosure. FIG. 1 is a flowchart of an embodiment of a method for data transmission provided in the present disclosure. As shown in FIG. 1, the method specifically includes the following steps:

101: a first mobile device obtains authentication data to be transmitted.

The method for data transmission provided in the present disclosure is primarily carried out by an apparatus for data transmission which may particularly be any one of, or software or an application installed on, two or more mobile devices that need to transmit data.

102: the first mobile device performs protocol encapsulation, encoding and modulation on the authentication data to obtain modulated authentication data.

103: the first mobile device loads the modulated authentication data onto a sound wave and transmits the sound wave to a second mobile device within a predefined range, so that the second mobile device returns an authentication success message to the first mobile device after the second mobile device has successfully performed demodulation, decoding and protocol handling on the modulated authentication data.

In order to ensure that the sound wave transmitted by the first mobile device reaches the position where the second mobile device is located, the sound wave may be an ultrasonic wave with a frequency greater than or equal to 25 kHz.

In particular, when the first mobile device and the second mobile device need to transmit data, the first mobile device may, with an associated keystroke, initiate functions of transmitting and receiving a sound wave for the first mobile device, so that the first mobile device may transmit or receive the sound wave loaded with data. For example, the first device may transmit a sound wave loaded with authentication data; and the second mobile device may also initiate the functions of transmitting and receiving the sound wave for the second mobile device with an associated keystroke.

An optional authentication mechanism between the first mobile device and the second mobile device may be that the authentication data to be transmitted may carry an identification of the first mobile device. After the first mobile device loads the modulated authentication data onto the sound wave and transmits the sound wave to the second mobile device within the predefined range, if the identification of the first mobile device is obtained after the second mobile device performs demodulation, decoding and protocol handling on the modulated authentication data, the second mobile device has been successfully authenticated, and returns an authentication success message carrying the identification of the second mobile device to the first mobile device. Otherwise, if the second mobile device obtains nothing other than random code or irrelevant data after the demodulation, decoding and protocol handling on the modulated authentication data, the second mobile device fails the authentication, and does not return any authentication success message.

It should be noted that the data to be transmitted may also carry other data, such as pre-negotiated values or images, which will not be limited herein. The data carried by the authentication data to be transmitted may be configured according to specific situations.

Further, in order to improve security for the data transmission, the first mobile device may encrypt the modulated authentication data according to a predefined password. Accordingly, after the second mobile device receives the modulated authentication data, it may begin from decrypting the modulated authentication data, and only proceed to the demodulation, decoding and protocol handling if the decryption has succeeded. If the decryption fails, so does the authentication.

104: the first mobile device receives the authentication success message returned from the second mobile device.

105: the first mobile device obtains data to be transmitted, performs protocol encapsulation, encoding and modulation on the data to be transmitted to obtain modulated data to be transmitted, loads the modulated data to be transmitted onto a sound wave, and transmits the sound wave to the second mobile device that has succeeded in the authentication.

Optionally, in order to reduce power consumption and save energy, in a first implementation scenario, the authentication success message carries: a received power of the sound wave.

Accordingly, before step 105, the method may further include: the first mobile device obtains a transmitted power of the sound wave; the first mobile device determines the distance between the first mobile device and the second mobile device according to the received power and the transmitted power of the sound wave; and the first mobile device adjusts the transmitted power of the sound wave according to the distance.

In the present embodiment, the first mobile device may adjust attenuation for the sound wave if the distance between the second mobile device and the first mobile device is small, so that the second mobile device receives the sound wave while other mobile devices farther from the first mobile device do not. This may save energy while still make sure the second mobile device receives the sound wave, as well as avoid possible interference to the first mobile device when other mobile devices farther from the first mobile device provide feedback to or echo the sound wave.

Optionally, in order to reduce power consumption and save energy, in a second implementation scenario, the authentication success message carries: location information of the second mobile device.

Accordingly, before step 105, the method may further include: the first mobile device obtains location information of itself; the first mobile device determines the distance between the first mobile device and the second mobile device and the direction of the second mobile device relative to the first mobile device according to the location information of itself and the location information of the second mobile device; and the first mobile device adjusts the transmitted power and an emission direction of the sound wave according to the distance and the direction.

In the present embodiment, the first mobile device may adjust the attenuation and the direction of the sound wave, so that only the second mobile device at its location receives the sound wave while other mobile devices at other positions receive no or only very poor sound wave, thereby saving energy while ensuring that the second mobile device receives the sound wave and avoiding interference to the first mobile device when other mobile devices farther from the first mobile device provide feedback to or echo the sound wave.

In this embodiment, the first mobile device transmits authentication data to the second mobile device via the sound wave, and transmits data to the second mobile device via a sound wave after the second mobile device has been successfully authenticated, thereby achieving data transmission between the first mobile device and the second mobile device via a sound generating apparatus, such as a microphone and a loudspeaker, in the first mobile device and the second mobile device, with small power consumption and no interference to the antenna related to the voice call of the mobile device.

Persons of ordinary skill in the art may understand that, all or a part of steps of the foregoing method embodiments may be implemented by a program instructing relevant hardware. The foregoing program may be stored in a computer-readable storage medium. When the program runs, the steps of the foregoing embodiment methods are performed. The foregoing storage medium includes various mediums capable of storing program codes, such as a ROM, a RAM, a magnetic disk, or an optical disc.

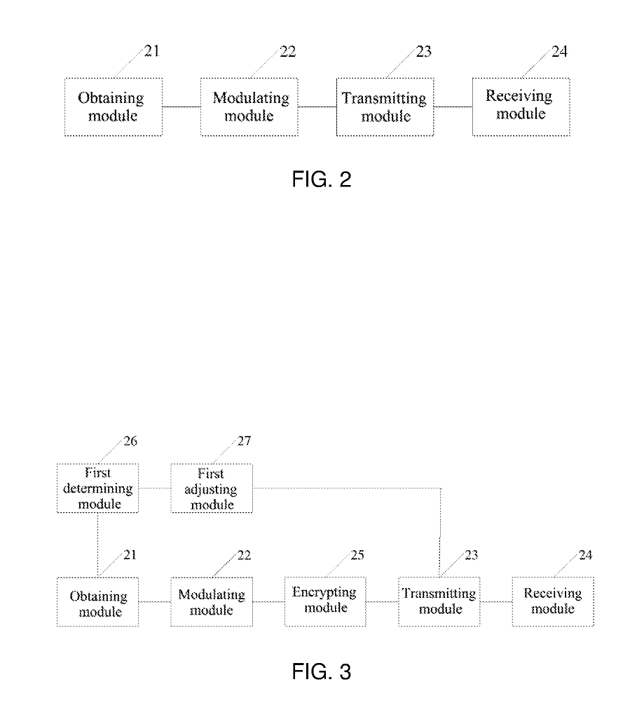

FIG. 2 is a structural schematic diagram of an embodiment of an apparatus for data transmission provided in the present disclosure. As shown in FIG. 2, the apparatus includes:
an obtaining module 21, a modulating module 22, a transmitting module 23, and a receiving module 24;
the obtaining module 21 being configured to obtain authentication data to be transmitted;
the modulating module 22 being configured to perform protocol encapsulation, encoding and modulation on the authentication data to obtain modulated authentication data;

the transmitting module 23 being configured to load the modulated authentication data onto a sound wave and transmit the sound wave to a second mobile device within a predefined range, so that the second mobile device returns an authentication success message to a first mobile device after the second mobile device has successfully performed demodulation, decoding and protocol handling on the modulated authentication data.

In order to ensure that the sound wave transmitted from the first mobile device reaches the second mobile device at its location, the sound wave may be an ultrasonic wave with a frequency greater than or equal to 25 kHz.

The receiving module 24 is configured to receive the authentication success message returned from the second mobile device.

The obtaining module 21 is further configured to obtain data to be transmitted.

The modulating module 22 is further configured to perform protocol encapsulation, encoding and modulation on the data to be transmitted to obtain modulated data to be transmitted.

The transmitting module 23 is further configured to load the modulated data to be transmitted onto a sound wave and transmit the sound wave to the second mobile device that has succeeded in the authentication.

Further, as shown in FIG. 3, which is a structural schematic diagram of a further embodiment of an apparatus for data transmission provided in the present disclosure, in order to improve security for the data transmission, the apparatus may further include: an encrypting module 25;
the encrypting module 25 being configured to encrypt the modulated authentication data according to a predefined password before the transmitting module 23 loads the modulated authentication data onto the sound wave and transmits the sound wave to the second mobile device within a predefined range. Accordingly, after the modulated authentication data is received, the second mobile device may begin from decrypting the modulated authentication data, and only proceed to the demodulation, decoding and protocol handling if the decryption has succeeded. If the decryption fails, so does the authentication.

Optionally, in order to reduce power consumption and save energy, in a first implementation scenario, the authentication success message carries: a received power of the sound wave.

Accordingly, the apparatus further includes: a first determining module 26 and a first adjusting module 27;
the obtaining module 21 being further configured to obtain a transmitted power of the sound wave before the transmitting module 23 loads the modulated data to be transmitted onto the sound wave and transmits the sound wave to the second mobile device that has succeeded in the authentication;
the first determining module 26 being configured to determine a distance between the first mobile device and the second mobile device according to the received power and the transmitted power of the sound wave; and
the first adjusting module 27 being configured to adjust the transmitted power of the sound wave according to the distance.

Optionally, in order to reduce power consumption and save energy, in a second implementation scenario, the authentication success message carries: location information of a second mobile device.

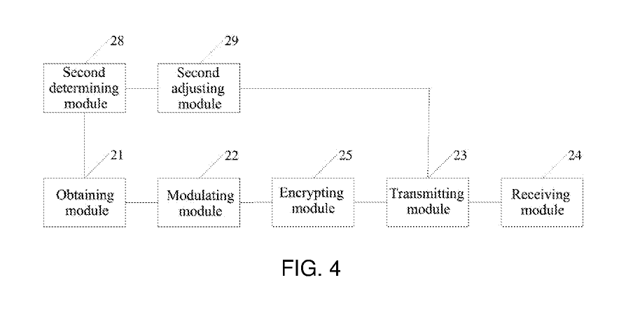

Accordingly, the apparatus may further include: a second determining module 28 and a second adjusting module 29, which are shown in FIG. 4, a structural schematic diagram of another embodiment of an apparatus for data transmission provided in the present disclosure.

The obtaining module 21 is further configured to obtain location information of itself before the transmitting module 23 loads the modulated data to be transmitted onto the sound wave and transmits the sound wave to the second mobile device that has succeeded in the authentication.

The second determining module 28 is configured to determine, according to the location information of the first mobile device and the location information of the second mobile device, a distance between the first mobile device and the second mobile device, and a direction of the second mobile device relative to the first mobile device.

The second adjusting module 29 is configured to adjust the transmitted power and a transmission direction of the sound wave according to the distance and the direction.

In this embodiment, the first mobile device transmits authentication data to the second mobile device via the sound wave, and transmits data to the second mobile device via a sound wave after the second mobile device has been successfully authenticated, thereby achieving data transmission between the first mobile device and the second mobile device via a sound generating apparatus, such as a microphone and a loudspeaker, in the first mobile device and the second mobile device, with small power consumption and no interference to the antenna related to the voice call of the mobile device.

Finally, it should be noted that the foregoing embodiments are merely intended for describing, rather than limiting, the technical solutions of the present disclosure. Although the present disclosure is described in detail with reference to the foregoing embodiments, persons of ordinary skill in the art should understand that it remains possible to make modifications to the technical solutions described in the foregoing embodiments, or make equivalent replacements to some or all technical features therein. However, these modifications or replacements do not make the essence of corresponding technical solutions depart from the scope of the technical solutions in the embodiments of the present disclosure.

What is claimed is:

1. A method for data transmission, comprising:
obtaining, by a first mobile device, authentication data to be transmitted;
performing, by the first mobile device, protocol encapsulation, encoding and modulation on the authentication data to obtain modulated authentication data;
by the first mobile device, loading the modulated authentication data onto a sound wave and transmitting the sound wave to a second mobile device within a predefined range, so that the second mobile device returns an authentication success message to the first mobile device after the second mobile device has successfully performed demodulation, decoding and protocol handling on the modulated authentication data;
receiving, by the first mobile device, the authentication success message returned from the second mobile device; and
by the first mobile device, obtaining data to be transmitted, performing protocol encapsulation, encoding and modulation on the data to be transmitted to obtain modulated data to be transmitted, loading the modulated data to be transmitted onto a sound wave, and transmitting the sound wave to the second mobile device that has been successfully authenticated.

2. The method according to claim 1, wherein the authentication success message carries:
a received power of the sound wave;
and before the first mobile device obtains data to be transmitted, performs protocol encapsulation, encoding and modulation on the data to be transmitted to obtain modulated data to be transmitted, loads the modulated data to be transmitted onto the sound wave, and transmits the sound wave to the second mobile device that has been successfully authenticated, the method further comprises:
obtaining, by the first mobile device, a transmitted power of the sound wave;
determining, by the first mobile device, a distance between the first mobile device and the second mobile device according to the received power and the transmitted power of the sound wave; and
adjusting, by the first mobile device, the transmitted power of the sound wave according to the distance.

3. The method according to claim 1, wherein the authentication success message carries:
location information of the second mobile device;
and before the first mobile device obtains data to be transmitted, performs protocol encapsulation, encoding and modulation on the data to be transmitted to obtain modulated data to be transmitted, loads the modulated data to be transmitted onto the sound wave and transmits the sound wave to the second mobile device that has been successfully authenticated, the method further comprises:
obtaining, by the first mobile device, location information of itself;
determining, by the first mobile device, a distance between the first mobile device and the second mobile device and a direction of the second mobile device relative to the first mobile device according to the location information of itself and the location information of the second mobile device; and
adjusting, by the first mobile device, the transmitted power and a transmission direction of the sound wave according to the distance and the direction.

4. The method according to claim 1, wherein before the first mobile device loads the modulated authentication data onto the sound wave and transmits the sound wave to a second mobile device within a predefined range, the method further comprises:
encrypting, by the first mobile device, the modulated authentication data according to a predefined password.

5. The method according to claim 1, wherein:
the sound wave is an ultrasonic wave with a frequency greater than or equal to 25 kHz.

6. An apparatus for data transmission, comprising:
an obtaining module, configured to obtain authentication data to be transmitted;
a modulating module, configured to perform protocol encapsulation, encoding and modulation on the authentication data to obtain modulated authentication data;
a transmitting module, configured to load the modulated authentication data onto a sound wave and transmit the sound wave to a second mobile device within a predefined range, so that the second mobile device returns an authentication success message to a first mobile device after the second mobile device has successfully performed demodulation, decoding and protocol handling on the modulated authentication data;
a receiving module, configured to receive the authentication success message returned from the second mobile device;
the obtaining module being further configured to obtain data to be transmitted;
the modulating module being further configured to perform protocol encapsulation, encoding and modulation on the data to be transmitted to obtain modulated data to be transmitted; and
the transmitting module being further configured to load the modulated data to be transmitted onto a sound wave and transmit the sound wave to the second mobile device that has been successfully authenticated.

7. The apparatus according to claim 6, wherein the authentication success message carries: a received power of the sound wave;
and the apparatus further comprises: a first determining module and a first adjusting module; the obtaining module is further configured to obtain a transmitted power of the sound wave before the transmitting module loads the modulated data to be transmitted onto the sound wave and transmits the sound wave to the second mobile device that has been successfully authenticated;
the first determining module is configured to determine a distance between the first mobile device and the second mobile device according to the received power and the transmitted power of the sound wave; and
the first adjusting module is configured to adjust the transmitted power of the sound wave according to the distance.

8. The apparatus according to claim 6, wherein the authentication success message carries: location information of the second mobile device;
and the apparatus further comprises: a second determining module and a second adjusting module;
the obtaining module is further configured to obtain location information of the first mobile device before the transmitting module loads the modulated data to be transmitted onto the sound wave and transmits the sound wave to the second mobile device that has been successfully authenticated;
the second determining module is configured to determine, according to the location information of the first mobile device and the location information of the second mobile device, a distance between the first mobile device and the second mobile device, and a direction of the second mobile device relative to the first mobile device; and
the second adjusting module is configured to adjust the transmitted power and a transmission direction of the sound wave according to the distance and the direction.

9. The apparatus according to claim 6, further comprising: an encrypting module;
the encrypting module being configured to encrypt the modulated authentication data according to a predefined password before the transmitting module loads the modulated authentication data onto the sound wave and transmits the sound wave to the second mobile device within a predefined range.

10. The apparatus according to claim 6, wherein:
the sound wave is an ultrasonic wave with a frequency greater than or equal to 25 kHz.
